(19) United States
(12) Patent Application Publication
(10) Pub. No.: US 2003/0033261 A1
(43) Pub. Date: Feb. 13, 2003

(54) Method for performing risk-based pricing of a service or good

(76) Inventor: William A. Knegendorf, Saunderstown, RI (US)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 10/101,489

(22) Filed: Mar. 18, 2002

Related U.S. Application Data
(60) Provisional application No. 60/276,676, filed on Mar. 16, 2001.
(60) Provisional application No. 60/281,520, filed on Apr. 4, 2001.

(51) Int. Cl. G06F 17/60; G06G 7/00; G06F 17/00

(52) U.S. Cl. 705/400; 705/4; 705/38

(57) ABSTRACT

Risk-based pricing may be used to determine a price charged for a good or service which itself reduces risk. The price charged for the good or service may be priced in response to the amount of reduction in risk provided by the consumer good or service. For example, in a product hazard notification service that provides early notification to consumers of product hazards, the price of such a service to manufacturers may be determined on the basis of the reduction of risk produced by utilizing the notification service. The use of such a service may reduce an amount of premiums paid to, for example, an insurance company because overall risk to consumers and thus financial exposure to the insurance company are reduced. In this manner, the amount paid for the service is justified, at least in part, from the savings in insurance premiums (cost of risk). The maximum price of the service can be coordinated with the cost savings from the reduction in risk. By capping the price of the service by the amount of insurance premium savings, manufacturers are motivated to subscribe to the service, as there is no perceived increase in cost, and their amount of potential liability is reduced.

### RELATED APPLICATIONS

This application claims the benefit under Title 35 U.S.C. §19(e) of co-pending U.S. Provisional Application Serial No. 60/276,676, filed Mar. 16, 2001, entitled “METHODS AND APPARATUS FOR IMPROVED COLLECTION, HANDLING AND DISSEMINATION OF CONSUMER PRODUCT SAFETY INFORMATION” by Daniel Kaplan, David P. Goldsmith, and William A. Knegendorf, and U.S. Provisional Application Serial No. 60/281,520, filed Apr. 4, 2001, entitled “METHODS AND APPARATUS FOR IMPROVED COLLECTION, HANDLING AND DISSEMINATION OF CONSUMER PRODUCT SAFETY INFORMATION” by Daniel Kaplan, David P. Goldsmith, and William A. Knegendorf, both of which applications are incorporated by reference herein.

### FIELD OF THE INVENTION

The field of the invention relates generally to determining pricing of goods and services, and more particularly, determining pricing of a good or service based on risk.

### BACKGROUND

Risk-based pricing is frequently used in the insurance industry to assess, quantify, and charge the customer (the insured) in the form of insurance premiums. In general, the higher the risk that exists for the customer, the higher the premium charged to that customer. For example, in the auto industry, the amount of premium charged for an insurance policy is determined as a function of a number of factors, including, for example, the customer's driving history, year, make and model of car, etc. Risk-based pricing is also used in the financial industry to assess credit worthiness (or risk of default). There are many other applications where some of some form of risk-based pricing is used.

Risk-based pricing models generally include assessing the risk associated with an individual and assigning values to risk factors according to the personal situation of the individual. These factors are totalled to provide a composite risk value, and that risk value is correlated to the premium paid by the individual. This risk value may also be used by underwriters, investors, etc. to determine whether or not a financial project should be pursued (for example, based on credit risk, market risk, etc.). For example, risk factors associated with an individual's credit history, existing debt, etc. may be used and by an underwriter to determine a loan rate, determined the appeal of an investment project, and to assess the riskiness of the project. Underwriters typically make investment decisions based on the determined risk. The individual may be assigned to a risk class based upon these risk factors, and the type of loan they receive may be determined by the assigned risk class.

### SUMMARY OF THE INVENTION

According to one aspect of the invention, risk-based pricing may be used to determine a price charged for a good or service which itself reduces risk. The price charged for the good or service may be priced in response to the amount of reduction in risk provided by the consumer good or service. For example, in a product hazard notification service that provides early notification to consumers of product hazards, the price of such a service to manufacturers may be determined on the basis of the reduction of risk produced by utilizing the notification service. The use of such a service may reduce an amount of premiums paid to, for example, an insurance company because overall risk to consumers and thus financial exposure to the insurance company are reduced. In this manner, the amount paid for the service is justified, at least in part, for the savings in insurance premiums (cost of risk). According to one aspect of the invention, the maximum price of the service can be coordinated with the cost savings from the reduction in risk. By capping the price of the service at the amount of insurance premium savings, manufacturers are motivated to subscribe to the service, as there is no perceived increase in cost, and their amount of potential liability is reduced.

According to one aspect of the invention, a method is provided for generating a price charged to an entity for a consumer good or service. The method comprises determining a maximum price for the consumer good or service, the maximum price being determined by a risk-based pricing analysis, wherein the maximum price is determined at least in part by an amount of reduction in risk provided by the consumer good or service. According to one embodiment of the invention, the method comprises determining a minimum price that relates to base costs of the consumer good or service. According to another embodiment of the invention, the method further comprises determining a range of pricing for the consumer good or service, the range having a maximum price and wherein the maximum price of the range is determined based upon the maximum price of the consumer good or service.

According to another embodiment of the invention, the method further comprises determining within the range, a plurality of subranges, within one of which the price charged to the entity may reside. According to another embodiment of the invention, the subranges are defined based upon a multiplier of a minimum price. According to another embodiment, the multiplier is determined by adding factors related to an amount of risk associated with the entity.

According to another embodiment of the invention, the method further comprises assigning at least two multipliers to at least two respective risk groups of a plurality of risk groups. According to another embodiment of the invention, the method further comprises assigning multipliers to risk categories within each of the plurality of risk groups. According to another embodiment of the invention, the method further comprises acts of determining one or more risk categories that apply to the entity, calculating a sum of the at least two multipliers, and multiplying the multiplier sum by the minimum price to determine the price charged.

According to another embodiment of the invention, the act of determining the maximum price includes correlating the amount of reduction in risk to an amount saved as a result of reducing the risk. According to another embodiment of the invention, the entity is at least one of a group comprising a manufacturer, a reseller, and an importer. According to another embodiment of the invention, the consumer good or service is a notification service that provides notifications of a hazard related to one or more products provided by the entity.

According to another embodiment of the invention, the method further comprises notifying a consumer regarding the product hazard, determining that the consumer received the notification, and storing an indication that indicates that the consumer received the notification. According to another embodiment of the invention, the amount of reduction in risk is related to reducing at least one of identifying, at an earlier point in a product cycle, a product hazard related to one or more products provided by the entity, limiting exposure to a consumer of the one or more products by at least one of limiting an amount of one or more products distributed to consumers, identifying, to the consumers, that the hazard related to the one or more products exists, and reducing usage of the one or more products.

According to another embodiment of the invention, the amount of risk associated with the entity is based, at least in part, on risk associated with one or more products provided by the entity. According to another embodiment of the invention, the method further comprises determining a range of risk, determining, for the entity, risk associated with the entity within the range, and determining the price charged the entity based on the risk associated with the entity. According to another embodiment of the invention, the method further comprises assigning a maximum multiplier assigned to each of the at least two risk groups. According to another embodiment of the invention, the method further comprises determining a maximum amount charged for risk associated with a risk group.

Further features and advantages of the present invention as well as the structure and operation of various embodiments of the present invention are described in detail below with reference to the accompanying drawings. In the drawings, like reference numerals indicate like or functionally similar elements. Additionally, the left-most one or two digits of a reference numeral identifies the drawing in which the reference numeral first appears.

### BRIEF DESCRIPTION OF THE DRAWINGS

In the drawings:

FIG. 1 shows a process for determining a price for consumer good or service in accordance with one embodiment of the invention;

FIG. 2 shows a pricing range in accordance with one embodiment of the invention;

FIG. 3 shows a method for computing a risk multiplier in accordance with one embodiment of the invention;

FIGS. 4A-4C show example factors associated with risk in accordance with one embodiment of the invention; and

FIG. 5 shows a computer-based hazard notification system in accordance with one embodiment of the invention.

### DETAILED DESCRIPTION

Risk-based pricing models generally include assessing the risk associated with an individual and assigning values to risk factors according to the personal situation of the individual. These factors are generally totalled to provide a risk value, and that risk value is correlated to a premium paid by the individual.

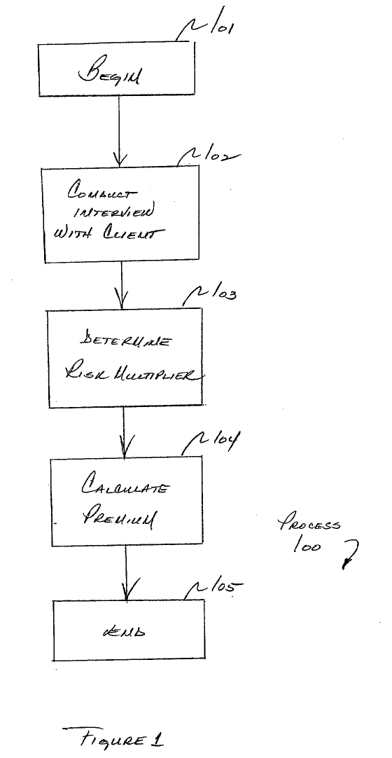

FIG. 1 shows a process 100 for determining a price for a consumer good or service in accordance with one embodiment of the invention. At block 101, process 100 begins. At block 102, an interview is conducted with the client to determine risk factors associated with the person, company, or other entity. The interview may be a face-to-face interview, a telephone interview, an interview by a computer system (e.g. an application filled out by the client through a computer-based system) or any other method for obtaining risk-related information. Other methods for obtaining information relevant to risk factors may be used.

At block 103, a risk multiplier is determined based on the risk factors determined through the client interview. A risk multiplier is, according to one embodiment of the invention, a number having a value which is indicative of the riskiness of the particular individual, company, or entity. This multiplier is used to determine the premium paid by the individual at block 104. At block 105, process 100 ends.

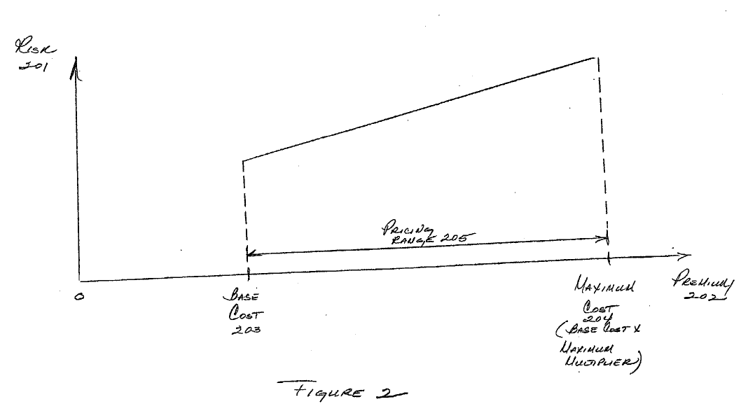

FIG. 2 is a graph illustrating a pricing range within which a premium charged to the individual may fall. In particular, FIG. 2 shows a graph of risk 201 versus the amount of premium 202 paid for a particular good or service. A pricing range 205 may be determined such that the premium paid by an individual is at least equal or greater than a base cost 203 but does not exceed a maximum cost 204. Also, the maximum cost may be expressed as the base cost 203 multiplied by a maximum value of a multiplier. As discussed, the value of the multiplier is indicative of the amount of risk associated with the individual. Thus, the value of the multiplier may range between a value of zero and a maximum multiplier, which, when multiplied by base cost 203 equals maximum cost 204. If the multiplier value is less than 1, the individual may be charged the base cost 203.

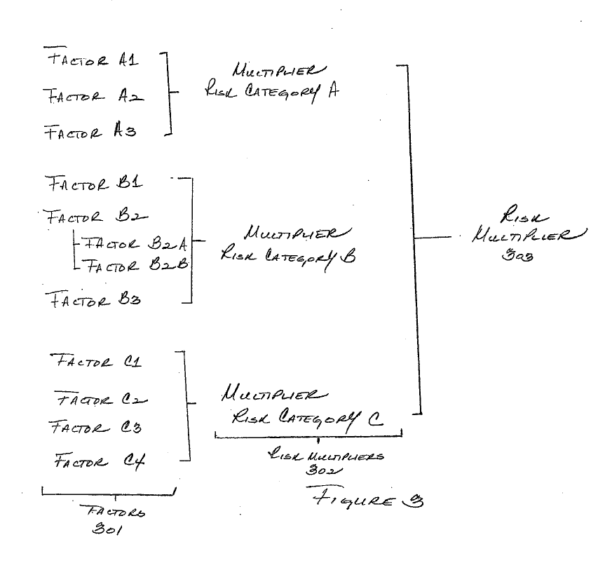

FIG. 3 shows a method for computing a risk multiplier in accordance with one embodiment of the invention. As shown in FIG. 3, factors that relate to the risk of an individual may contribute to a risk multiplier 303. For example, risk multiplier 303 may be determined based on a number of multipliers in different risk categories. As shown, risk multiplier 303 is determined based on risk multipliers 302 which include multipliers for risk categories A, B, and C. Within each risk category are a number of factors which contribute to the total risk for that category. For example, factors A1-A3 contribute to the multiplier for risk category A, factors B1-B3 contribute to the multiplier for risk category B, and factors C1-C4 contribute to the multiplier for risk category C.

Further, factors 301 may also include a number of subfactors which contribute to a multiplier value for that particular factor. As shown in FIG. 3, factor B2 includes two subfactors B2A and B2B which determine the value for factor B2.

As discussed above with reference to FIG. 2, risk multiplier 303 may reside within a range of values, and each of the factors related to the riskiness of a particular individual may contribute to that risk multiplier. For example, factors A1-A3 may be combined in such a manner to determine the multiplier for risk category A. Similarly, multipliers for individual risk categories A-C may be combined to determine risk multiplier 303. This relation may be, for example, a simple summation of factors to determine a multiplier of a risk category, and a simple summation of multipliers for individual risk categories to determine the risk multiplier 303. It should be appreciated that any other relation may be used to determine category and risk multipliers, e.g., weighted summation, function, or other relation, and the invention is not limited to any particular implementation.

Also, the presence (or non presence) of any one of these factors 301 may be used to indicate the value of risk assigned to that factor. For example, whether a particular individual exhibits the type of risk associated with a factor may be a “yes” or “no” answer, and the value attributed to that particular factor may be indicative of the increase in risk presented by the occurrence or non-occurrence of that factor. For example, the multiplier for risk category A may have a maximum value of 1.5, and the maximum value for each factor A1-A3 may be, 0.2, 0.3, and 1, respectively. That is, factor A3 presents relatively more risk than factors A2 or A1. If an individual exhibits risk factors A1 and A2, but not A3, according to this example, his/her risk multiplier for category A has a value of 0.5 (0.2 (A1)+0.3 (A2)).

For instance, the maximum value of the multiplier associated with risk category B may be 2.5, and the risk multiplier associated with risk category C may be 4. Therefore, the maximum value of the risk multiplier 303 may be, according to this example, a value of 7. For a base cost 203 of $20,000, the maximum cost 204 of a premium charged to an individual having risk factors that achieve a risk multiplier 303 value of 7 is $140,000. Of course, if the risk multiplier value associated with an individual is 0, the individual can be charged at least the base cost 203 which may be determined based on costs of providing the consumer good or service. In this example, the individual is charged $20,000. If the service includes operating costs such as employee time, computer system costs, or other fees and expenses, base cost 203 may cover these costs, at least in part. Further, the base price 203 may be indicative of the value of the particular good or service provided to the individual.

Hazard Notification Service

According to one aspect of the invention, the maximum price 204 of the service of good is determined based on the cost of the reduction in risk of the service or good. For example, a product hazard notification service may be provided that provides clients early notification of product hazards, and the price of such a service to manufacturers may be determined based on the reduction of risk produced by utilizing the notification service. Such a notification system and service is described in the co-pending application filed Mar. 18, 2002, entitled “METHOD FOR PROVIDING HAZARD INFORMATION” by William A. Knegendorf, et al., Attorney Docket Number W00572/70003, the contents of which are incorporated herein by reference in their entirety.

There is a need for reducing the risk to companies as a result of putting their products in the stream of commerce. Currently, there is no easy way to notify consumers of dangers posed by their products. As a result, manufacturers, importers, retailers, distributors, etc. continue to sell and distribute harmful products, increasing their exposure, amount of risk, and potential liability to consumers for producing and/or selling harmful products.

One way of reducing companies' risk is to more efficiently notify consumers of harmful products. As a result, the company may eliminate a greater percentage of harmful products on the market. Typically, a majority of harmful products are not turned in response to a product recall as many consumers do not get the recall notification, or otherwise are not motivated to return the product. On average, greater than 60% of harmful products associated with a recall are not recovered. These non-recovered products endanger consumers and are a significant financial exposure to companies.

Also, if receipt of hazard notifications could be tracked, the amount of lawsuits (and, therefore, risk to the company) may be reduced. In particular, because notice to individual consumers regarding the product hazard can be tracked, a company may be able to prove that a consumer received notice of the hazard and thus escape liability for the injury. This amount of risk reduction may translate to an identifiable amount of cost savings, and this cost savings may result in lower premiums charged by the insurance company. The change in premiums may be used to determine a price for the notification service. Because premiums are lowered in response to the company subscribing to the notification service, the company is motivated to subscribe to the service. Also, if the price of the service is offset by the cost of the insurance savings, the company perceives no increase in cost to have the notification service, and therefore the company will be motivated to use the service. Further, the company's reputation may be enhanced by using the service, because consumers identify that the company invests in the safety of their products, and this may be a selling point to consumers. Also, because such a notification service results in decreasing the amount of safety incidents involving the company's products, the company's reputation is improved.

In summary, various aspects of a notification service/system described above may provide one or more of the following benefits to a company:

Limits consumer's potential exposure to product

As soon as safety hazard is confirmed, notifies end-users and entire distribution chain of safety hazard

Stops usage of the defective product

Reduces company's exposure

Protects the company's reputation by avoiding injury to consumers

Lowers recall costs because recalls are typically handled through third parties that charge significantly more per consumer than an automatic notification system.

With such a service, there may be a membership fee charged to the company based upon a risk assessment of that company. A risk profile is generated as a result of that risk assessment, and the risk profile serves as the basis of the annual fee calculation. Companies that create higher levels of risk by their product line choices will be able to reduce their risk more significantly than a company that creates little or no risk with their product lines. For example, a company that does little or no manufacturing and has very few factors that contribute to risk would not be able to appreciably reduce their risk to justify subscription to the service. However, companies in high-risk lines of business may see an instant payoff in terms of lowering risk.

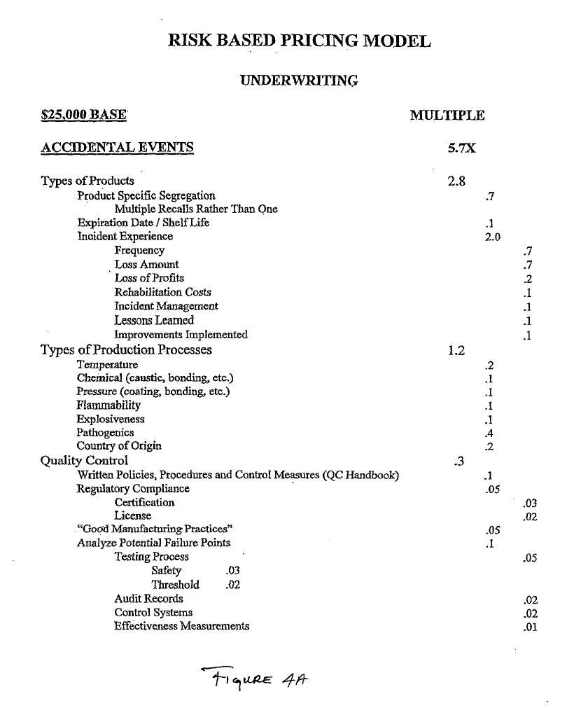

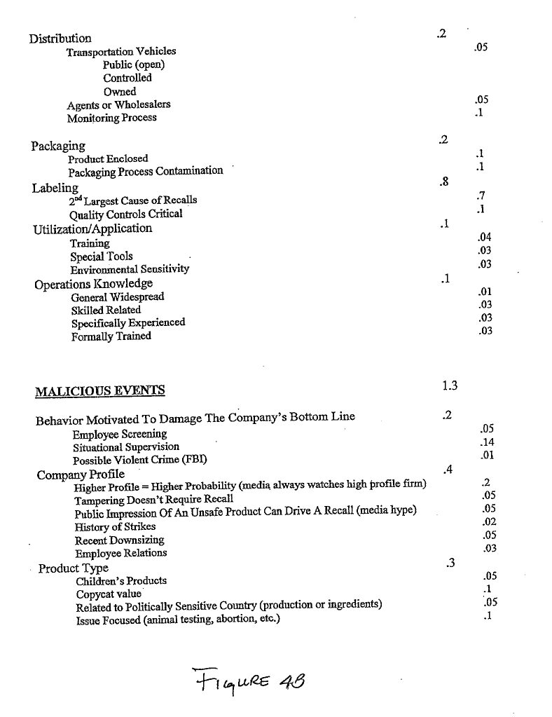

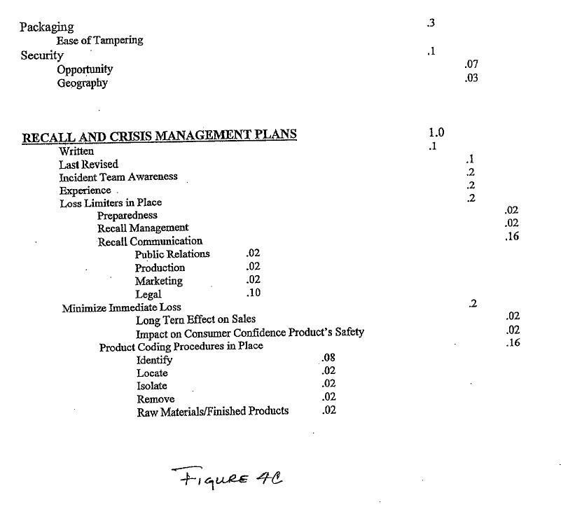

FIGS. 4A-4C show example factors associated with risk in accordance with one embodiment of the invention. More specifically, there may be a number of risk factors that contribute to a risk multiplier. These factors may reside in a number of categories such as, for example, “Accidental Events,” “Malicious Events,” and “Recall and Crisis Management Plans,” as shown in FIGS. 4A-4C.

These risk factors may each relate to risk due to product hazards, and each factor value may be indicative of the relevance of the factor to risk of the category. Similarly, each risk category has a related risk multiple which is indicative of the category's contribution to overall risk. For example, the “Accidental Events” category has a maximum risk multiple value of 5.7, whereas the “Malicious Events” category has a substantially smaller maximum value of 1.3, indicating that the “Accidental Events” category has a more significant effect on total risk than the “Malicious Events” category. This difference may be attributed, for example, to the relative occurrence of accidental events vs. malicious events, and may also relate to the relative occurrences of each type of event (e.g., accidents are more common than malicious events, and, therefore there is a higher risk attributed to these types of events).

These risk factors may in turn have subfactors associated with them. Also, these subfactors may have their own subfactors. For example, as shown in FIG. 4A, the risk factor “Quality Control” that indicates the relative risk of elements related to quality control may have a subfactor that relates to analyzing potential failure points of the quality control process (“Analyze Potential Failure Points”). This factor may have associated subfactors that indicate the relative risk of each of these potential failure points (e.g., problems with the testing process (subfactor “Testing Process”), problems with the auditing and audit records (subfactor “Audit Records”), etc. These factors, if present, may be combined to determine a risk multiplier which can be used to determine the fee charged for the notification service. Risk factor values may be modified from time to time, and a change in one factor may necessitate a change in one or more other factors and/or changes in other categories. According to one embodiment of the invention, the value of the overall risk multiplier remains the same, and the values of risk factors and/or their associated risk categories may be adjusted so that the multiplier remains constant.

It should be appreciated that other factors and their arrangements are possible, and the invention is not limited to any particular implementation.

The invention may be practiced, for example, in a system that relates product hazard information between consumers, manufactures and importers, government agencies and insurance providers. Such a system is more fully described in U.S. Patent Application filed Mar. 18, 2002 entitled “SYSTEM AND METHOD FOR PROVIDING PRODUCT HAZARD INFORMATION” by William A. Knegendorf, et al. under Attorney Docket No. W00572/70003, the contents of which application are incorporated by reference in their entirety.

Computer-Based System

As discussed above, risk-based pricing concepts may be used to determine pricing of a hazard notification service. Risk reduction provided by such service may be used to determine the price of the service. In such a system:

users may specify the types of product hazards they wish to receive, e.g., for product areas of interest (e.g., food recalls) or particular products that they use (e.g., Graco strollers).

because hazard information is communicated immediately to consumers, consumers may stop use of the product sooner, and therefore risk or injury and liability is decreased.

by providing a receipt indicating that a consumer received the hazard notification, the amount of costs/risk to insurers is reduced as the number of claims against the company are reduced (because documentation is kept regarding a consumer's notice of a product hazard, that consumer would be less apt to sue if the consumer was injured after having received the notice while continuing to use the product, or would easily dismiss fraudulent cases where an injury was “staged.”)

notification occurs earlier in the product cycle to reduce the insured's exposure

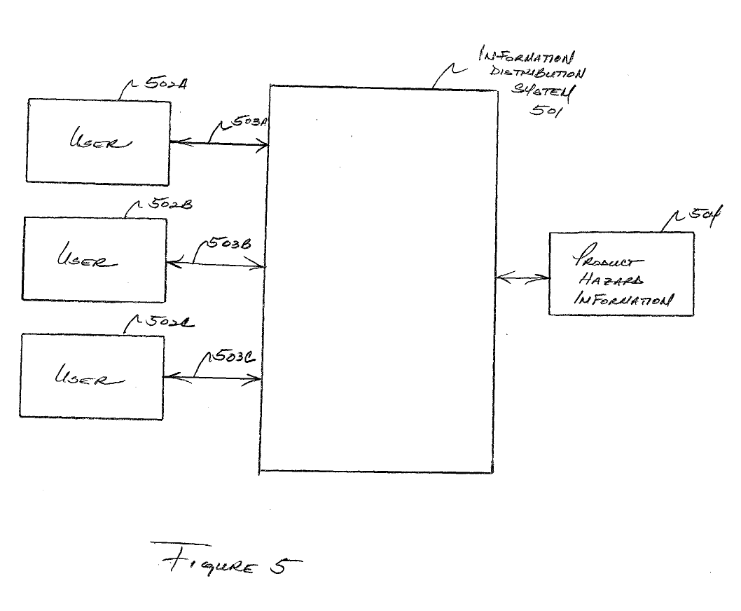

FIG. 5 shows a computer-based hazard notification system in accordance with one embodiment of the invention. In particular, information distribution system 501 is configured to distribute product hazard information 504 to one or more users 502A-502C. A user may be, for example, an individual, a company, or other entity that should receive product hazard information. A product may be, for example, any good or service placed in the stream of commerce. Product hazard information 504 refers to information regarding a product that relates to its usability or functionality, and may include, for example, official hazard notices identified by a manufacturer, provider, or importer of the product For example, product hazard information 504 may include information regarding a defect in the product, a warning regarding an unintended use of the product or other information that may reflect the safety of a product. Product hazard information 504 may be, for example, may be provided by a manufacturer of the product, a consumer safety interest group, the government, a distributor of the product, or any other entity that may produce information related to product hazards.

System 501 may include one or more general-purpose computer systems that perform distribution of product hazard information 504. System 501 may include, for example, server-based systems that distribute product hazard information to one or more users 502A-502C. Hazard information 504 may be stored in a database associated with system 601 and may be distributed to users 502A-502C over one or more communication links 503A-503C. Links 503A-503C may be, for example, network links between computers, telephone links that transfer voice or data to a user. For example, system 501 may include one or more HTTP (Hyper Text Transfer Protocol) that transfer data using the TCP/IP communication protocol. This information is transferred to a user who may be, for example, using a browser program executing on a computer system to review product hazard information 504. Further, a user may utilize a telephone system to access hazard information 504. It should be appreciated that any system or method may be used to access such information, and the invention is not limited to any particular method.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

What is claimed is:

1. A method for generating a price charged to an entity for a consumer good or service, the method comprising:
determining a maximum price for the consumer good or service, said maximum price being determined by a risk-based pricing analysis, wherein the maximum price is determined at least in part by an amount of reduction in risk provided by the consumer good or service.

2. The method according to claim 1, further comprising determining a minimum price that relates to base costs of the consumer good or service.

3. The method according to claim 1, further comprising determining a range of pricing for the consumer good or service, the range having a maximum price and wherein the maximum price of the range is determined based upon the maximum price of the consumer good or service.

4. The method according to claim 3, further comprising determining within the range, a plurality of subranges, within one of which the price charged to the entity may reside.

5. The method according to claim 4, wherein the subranges are defined based upon a multiplier of a minimum price.

6. The method according to claim 5, wherein the multiplier is determined by adding factors related to an amount of risk associated with the entity.

7. The method according to claim 6, further comprising assigning at least two multipliers to at least two respective risk groups of a plurality of risk groups.

8. The method according to claim 7, further comprising assigning multipliers to risk categories within each of the plurality of risk groups.

9. The method according to claim 7, further comprising acts of:
determining one or more risk categories that apply to the entity;
calculating a sum of the at least two multipliers; and
multiplying the multiplier sum by the minimum price to determine the price charged.

10. The method according to claim 1, wherein the act of determining the maximum price includes correlating the amount of reduction in risk to an amount saved as a result of reducing the risk.

11. The method according to claim 1, wherein the entity is at least one of a group comprising:
a manufacturer;
a reseller; and
an importer.

12. The method according to claim 1, wherein the consumer good or service is a notification service that provides notifications of a hazard related to one or more products provided by the entity.

13. The method according to claim 12, further comprising:
notifying a consumer regarding the product hazard;
determining that the consumer received the notification; and
storing an indication that indicates that the consumer received the notification.

14. The method according to claim 10, wherein the amount of reduction in risk is related to reducing at least one of:
identifying, at an earlier point in a product cycle, a product hazard related to one or more products provided by the entity;
limiting exposure to a consumer of the one or more products by at least one of:
limiting an amount of one or more products distributed to consumers;
identifying, to the consumers, that the hazard related to the one or more products exists; and
reducing usage of the one or more products.

15. The method according to claim 6, wherein the amount of risk associated with the entity is based, at least in part, on risk associated with one or more products provided by the entity.

16. The method according to claim 1, further comprising:
determining a range of risk;
determining, for the entity, risk associated with the entity within the range; and
determining the price charged the entity based on the risk associated with the entity.

17. The method according to claim 7, further comprising assigning a maximum multiplier assigned to each of the at least two risk groups.

18. The method according to claim 17, further comprising determining a maximum amount charged for risk associated with a risk group.
